(19) United States
(12) Patent Application Publication
(10) Pub. No.: US 2016/0210667 A1
(43) Pub. Date: Jul. 21, 2016

(54) Greedy Contextualized Rewrites

(71) Applicant: Shripad THITE, San Francisco, CA (US)

(72) Inventor: Shripad THITE, San Francisco, CA (US)

(73) Assignee: Google Inc., Mountain View, CA (US)

(21) Appl. No.: 13/452,411

(22) Filed: Apr. 20, 2012

Related U.S. Application Data
(60) Provisional application No. 61/481,528, filed on May 2, 2011.

(51) Int. Cl. G06F 17/30; G06Q 30/02

(52) U.S. Cl. CPC G06Q 30/0256; G06F 17/30864; G06F 17/3053

(57) ABSTRACT

Methods, systems, and apparatus, including computer programs encoded on a computer storage medium, for generating rewrites are disclosed. In one embodiment, an original rewrite operation is identified with a source term and a target term, and queries containing the source term are identified. For each query, an importance score is identified for the source term, and for an additional term prior to or after the source term. If the importance weight of the additional term is greater than the source term, the additional term may be added to a new rewrite source. If the number of times the new rewrite source appears in the queries meets a threshold, a new rewrite operation may be generated which specifies the source term should be replaced with the target term, and including the additional term.

### CROSS-REFERENCE TO RELATED APPLICATIONS

This application claims the benefit of U.S. Provisional Appl. No. 61/481,528, filed May 2, 2011, which is hereby incorporated by reference in its entirety.

### BACKGROUND

The Internet provides access to a wide range of resources. For example, web pages for particular subjects are accessible over the Internet. Access to these resources presents opportunities for advertisements to be provided with the resources. A web page can, for example, include advertisement slots in which advertisements can be presented. These advertisements slots can be defined for presentation with a web page, for example, in a pop-up window. The advertisements slots can also be defined in the web page.

When a user performs a search using query terms, the query terms are used to identify relevant advertisements for the slots. The advertisements can be identified a number of ways. One way is if they are associated with keywords that match the query. Other times the advertisements can be identified based on an expanded match, where the query has been associated with keywords by an advertisement system, and these keywords are used to identify relevant advertisements. These keywords can be generated by applying rewrite operators to rewrite the queries. However, the context of the query may not be included.

### BRIEF SUMMARY

Embodiments include systems and methods for preserving the context of a query to be rewritten. According to an embodiment, a method may include identifying an original rewrite operation including a source term and a target term, and one or more queries, wherein each of the queries includes the source term. For each query, a first occurrence of the source term is identified, and an importance weight is identified for the source term. A determination is made as to whether the query includes additional terms prior to the source term. If the query includes additional terms, an importance weight for an additional term prior to the source term is identified. If the importance weight of the additional term prior to the source term is greater than the importance weight of the first term in the source term, a new rewrite source is generated that includes the source term and the additional term prior to the source term. A determination is made to identify how many times the new rewrite source appears in the one or more queries. If the number meets a threshold, a final rewrite operation is generated, where the final rewrite operation specifies replacing the source term in the new rewrite source with the target term.

According to another embodiment, a system may include an advertisement engine configured to identify an original rewrite operation including a source term and a target term, and one or more queries, wherein each of the queries includes the source term. For each query, the advertisement engine may identify a first occurrence of the source term, and identify an importance weight for the source term. A determination is made as to whether the query includes additional terms prior to the source term. If the query includes additional terms, an importance weight for an additional term prior to the source term is identified. If the importance weight of the additional term prior to the source term is greater than the importance weight of the first term in the source term, a new rewrite source is generated that includes the source term and the additional term prior to the source term. A determination is made to identify how many times the new rewrite source appears in the one or more queries. If the number meets a threshold, a final rewrite operation is generated, where the final rewrite operation specifies replacing the source term in the new rewrite source with the target term.

According to another embodiment, a computer readable storage medium encoded with a computer program is provided. The program comprising instructions that when executed by one or more processors cause the one or more processors to perform operations comprising identifying an original rewrite operation including a source term and a target term, and identifying one or more queries, wherein each of the queries includes the source term; identifying queries, and identifying a rewrite operator, wherein the rewrite operator includes a function to rewrite a query. For each query, a first occurrence of the source term is identified, and an importance weight is identified for the source term. A determination is made as to whether the query includes additional terms prior to the source term. If the query includes additional terms, an importance weight for an additional term prior to the source term is identified. If the importance weight of the additional term prior to the source term is greater than the importance weight of the first term in the source term, a new rewrite source is generated that includes the source term and the additional term prior to the source term. A determination is made to identify how many times the new rewrite source appears in the one or more queries. If the number meets a threshold, a final rewrite operation is generated, where the final rewrite operation specifies replacing the source term in the new rewrite source with the target term.

Further embodiments, features, and advantages, as well as the structure and operation of the various embodiments are described in detail below with reference to accompanying drawings.

### BRIEF DESCRIPTION OF THE DRAWINGS/FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is rewrite operation example.

FIG. 2 is a block diagram of an example environment in which an advertisement system manages advertising services.

FIG. 3 is a flowchart illustrating a method for generating rewrite operations, according to an embodiment.

FIG. 4 is a flowchart illustrating a method for generating rewrite operations, according to an embodiment.

FIG. 5 is a swim lane diagram.

FIG. 6 is a system diagram that can be used to implement embodiments described herein.

### DETAILED DESCRIPTION OF THE INVENTION

Embodiments are described herein with reference to illustrations for particular applications. It should be understood that the invention is not limited to the embodiments. Those skilled in the art with access to the teachings provided herein will recognize additional modifications, applications, and embodiments within the scope thereof and additional fields in which the embodiments would be of significant utility.

Advertisers can bid on keywords for an advertisement. In some cases, when a user submits a search query, if the query terms match the keywords, the advertisement is identified as a responsive advertisement. Other times, terms in the search query are rewritten according to previously established rewrite rules or operators, to identify additional advertisements that may be responsive.

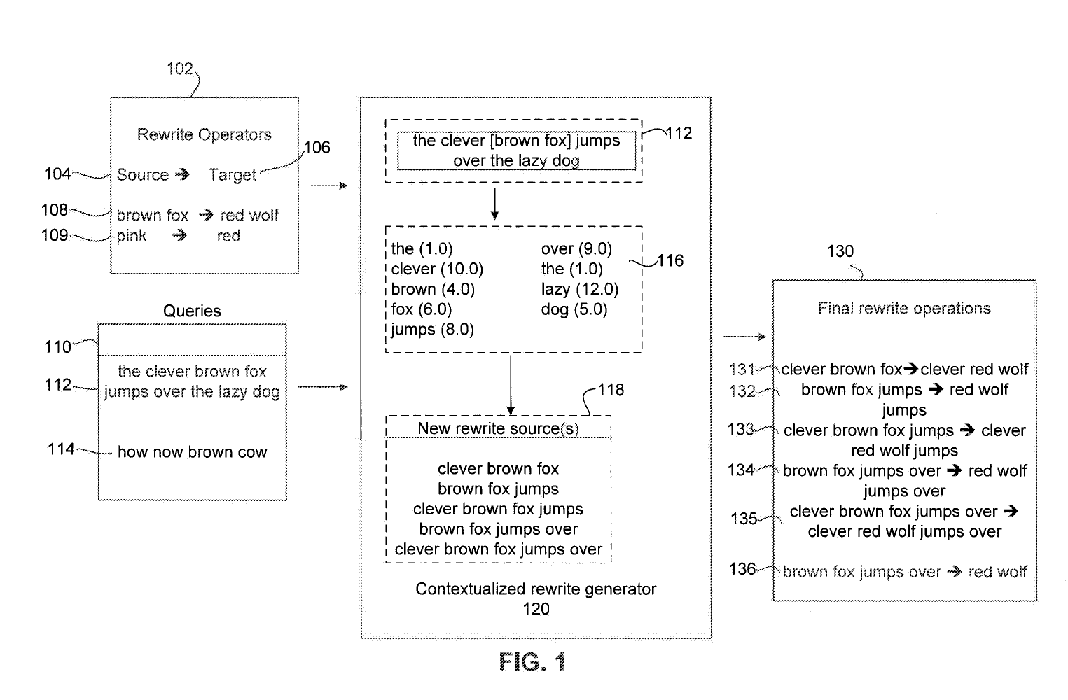

FIG. 1 is a diagram of system including a contextualized rewrite generator 120, in accordance with embodiments.

Rewrite operators 102 may be identified that are used to rewrite queries 110. A rewrite operator is a function that changes a query into another query. The operators can include deleting words, replacing words, sorting words, or adding words.

The rewrite operators specify a source term 104 and a target term 106. A source term and target term may be one or more words. In this example, rewrite operators 108 includes BROWN FOX→RED WOLF and rewrite operator 109 includes PINK→RED. Rewrite operator 108 BROWN FOX→RED WOLF specifies that when an instance of the source term BROWN FOX is located in a query, it should be replaced with the target term RED WOLF. Rewrite operator 109 PINK→RED specifies that when an instance of the word PINK is located in a query, it should be replaced with the word RED.

For certain queries, the context of a query may be useful to identify responsive advertisements. The context of the query can include surrounding words. For example, in the query “the clever brown fox jumps over the lazy dog”, the context of the query, including words prior to the source term, such as “clever”, or words subsequent to the source term, such as “jumps”, may be a frequently found phrase or term. Thus, rewriting a query while preserving the context of that query may be useful. For example, the query term with context “clever brown fox” may be rewritten according to the rewrite rules to generate “clever red wolf.”

The context of a query may be determined in a greedy manner by contextualized rewrite generator 120. For example, terms in a query may be associated with an importance weight. The importance weight may be based on the inverse document frequency (IDF) or inverse query frequency (IQF) of a particular term. The IDF of a particular term measures how rare or common a given term is in a collection of documents. The IQF of a particular term measures how rare or common a given term is in a collection of queries. In both IDF and IQF, the IDF or IQF is higher if the term is rarer. If the importance weight of a given term is greater than the importance weight of a source term, the given term may be useful in further search queries.

Thus, for example, each term in a given query may have a previously determined importance weight. As shown in FIG. 1, each query term in query 112 has an associated importance weight as shown in box 116. For example, query term “clever” has an importance weight of 10.0, query term “brown” has an importance weight of 4.0, query term “fox” has an importance weight of 6.0, query term “jumps” has an importance weight of 8.0, query term “over” has an importance weight of 9.0, query term “lazy” has an importance weight of 12.0, and query term “dog” has an importance weight of 5.0.

The importance weight of terms may be determined using a pre-computed lookup table for query term importance weights. Query terms may also be known as unigrams. For example, a lookup table may have been pre-computed that can determine the IDF of each term in a set of query terms. The lookup table may be stored, for example and without limitation, in a database. Other data structures may be used as well, as will be apparent to those of skill in the art.

Based on the importance weight of additional terms, new rewrite sources 118 may be generated, in accordance with embodiments, by contextualized rewrite generator 120. For example, new rewrite sources 118 “clever brown fox”, “brown fox jumps”, “clever brown fox jumps”, “brown fox jumps over”, and “clever brown fox jumps over”, may be generated as described below. In some embodiments, the importance weight of additional terms, relative to the importance weight of other terms, is used to generate new rewrite sources 118.

Based on the new rewrite sources 118, contextualized rewrite generator 120 may output final rewrite operations 130. In FIG. 1, for example, final rewrite operation 131 specifies that the phrase “clever brown fox” should be replaced with “clever red wolf”. Final rewrite operation 131 may be generated based on the importance weights of the various terms in the query. For example, starting with the word in the source term “brown” having an importance weight of 4.0, the previous term “clever” is identified to have an importance weight of 10.0. Since the importance weight of the term “clever” is greater than that of “brown”, “clever brown fox” may be added to new rewrite sources 118, and final rewrite operation 131 may be generated. In some cases, the contextualized rewrite generator 120 stops here and does not look for additional terms.

In other cases, the contextualized rewrite generator 120 may start by looking at terms after the source term. Final rewrite operation 132 specifies that the phrase “brown fox jumps over” should be replaced with “red wolf jumps over”. Starting with the word in the source term “fox” having an importance weight of 6.0, the first term after the source term, “jumps”, is identified to have an importance weight of 8.0. Since the importance weight of the term “jumps” is greater than that of “fox”, “brown fox jumps” may be added to new rewrite sources 118, and final rewrite operation 132 may be generated. Final rewrite operations 130 may be used to identify relevant advertisements to a user entering a search query.

Final rewrite operations 130 may also add terms both to prior to and after the source term. For example, because the identified importance weights of the terms “clever” and “jumps” are both greater than the importance weight of the source term “brown fox”, a new rewrite source 118 may be generated that contains “clever brown fox jumps”. Thus, a final rewrite operation 133 may be generated that specifies the phrase “clever brown fox jumps” should be replaced with “clever red wolf jumps”.

In some cases, if the importance weight of the term before the source term is higher than the source term, then a check can also be made if there is an additional term before that term. In the same manner, the terms after can be checked until a term is reached that includes an importance weight lower than the term prior to the term, or until no more terms are left. In this example, the term “over” exists after “jumps” and includes an importance weight of 9.0, which is higher than the importance weight of “jumps” which is 8.0. Therefore, a final rewrite operation 134 may be generated that specifies the phrase “brown fox jumps over” should be replaced with “red wolf jumps over.” Combinations of the above situations may lead to a final rewrite operation 135 that specifies “clever brown fox jumps over” should be replaced with “clever red wolf jumps over”.

In embodiments, final rewrite sources may specify that a new rewrite source should be replaced with the original target term. Therefore, a final rewrite operation 136 may be generated that specifies the phrase “brown fox jumps over” should be replaced with “red wolf”. Any of these rewrites can be used to rewrite queries and to identify relevant advertisements. Embodiments may capture the maximum contextual information available for a given query.

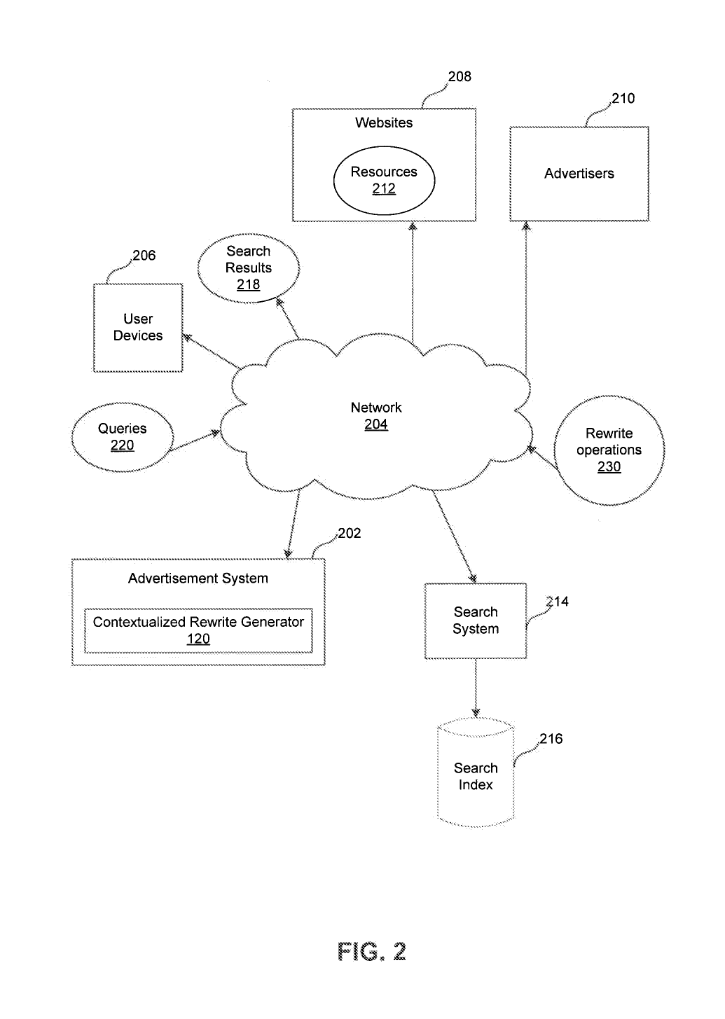

FIG. 2 is a block diagram of an example environment 200 in which an advertisement system 202 manages advertising services. The example environment 200 includes one or more networks 204, such as a local area network (LAN), a wide area network (WAN), the Internet, or a combination thereof. The network 204 connects user devices 206, websites 208, advertisers 210, and the advertisement system 202. The environment 200 may include many thousands of user devices 206, websites 208, and advertisers 210.

A website 208 is one or more resources 212 associated with a domain name and hosted by one or more servers. An example website is a collection of web pages formatted in hypertext markup language (HTML) that can contain text, images, multimedia content, and programming elements, such as scripts. Each website 208 is maintained by a publisher, which is an entity that controls, manages and/or owns the website 204.

A resource 212 is any data that can be provided over the network 204. A resource 212 is identified by a resource address that is associated with the resource 212. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as JavaScript scripts).

A user device 206 is an electronic device that is under control of a user and is capable of requesting and receiving resources over the network 204. Example user devices 206 include personal computers, mobile communication devices, and other devices that can send and receive data over the network 204. A user device 206 typically includes a user application, such as a web browser, to facilitate the sending and receiving of data over the network 204.

A user device 206 can request resources 212 from a website 208. In turn, data representing the resource 212 can be provided to the user device 206 for presentation by the user device 206. The data representing the resource 212 can also include data specifying a portion of the resource or a portion of a user display (e.g., a presentation location of a pop-up window or in a slot of a web page) in which advertisements can be presented. These specified portions of the resource or user display are referred to as advertisement slots.

To facilitate searching of these resources, the environment can include a search system 214 that identifies the resources by crawling and indexing the resources provided by the publishers on the websites 208. Data about the resources can be indexed based on the resource to which the data corresponds. The indexed and, optionally, cached copies of the resources are stored in an indexed cache 216.

User devices 206 can submit search queries 220 to the search system 214 over the network 204. In response, the search system 214 accesses the indexed cache 216 to identify resources that are relevant to the search query 220. The search system 214 identifies the resources in the form of search results 218 and returns the search results 218 to the user devices 206 in search results pages. A search result 218 is data generated by the search system 214 that identifies a resource that is responsive to a particular search query, and includes a link to the resource. An example search result 218 can include a web page title, a snippet of text or a portion of an image extracted from the web page, and the URL of the web page. Search results pages can also include one or more advertisement slots in which advertisements can be presented.

When a resource 212 or search results 218 are requested by a user device 206, the advertisement system 202 receives a request for advertisements to be provided with the resource 212 or search results 218. The request for advertisements can include characteristics of the advertisement slots that are defined for the requested resource or search results page, and can be provided to the advertisement system 202.

For example, a reference (e.g., URL) to the resource for which the advertisement slot is defined, a size of the advertisement slot, and/or media types that are available for presentation in the advertisement slot can be provided to the advertisement system 202. Similarly, keywords associated with a requested resource (“resource keywords”) or a search query 220 for which search results are requested can also be provided to the advertisement system 202 to facilitate identification of advertisements that are relevant to the resource or search query 220.

Based on data included in the request for advertisements, the advertisement system 202 can select advertisements that are eligible to be provided in response to the request (“eligible advertisements”). For example, eligible advertisements can include advertisements having characteristics matching the characteristics of advertisement slots and that are identified as relevant to specified resource keywords or search queries 220. In some implementations, advertisements having targeting keywords that match the resource keywords or the search query 220 are selected as eligible advertisements by the advertisement system 202.

A targeting keyword can match a resource keyword or a search query 220 by having the same textual content (“text”) as the resource keyword or search query 220. For example, an advertisement associated with the targeting keyword “daisy” can be an eligible advertisement for an advertisement request including the resource keyword “daisy.” Similarly, the advertisement can be selected as an eligible advertisement for an advertisement request including the search query “daisy.”

A targeting keyword can also match a resource keyword or a search query 220 by having text that is identified as being relevant to a targeting keyword or search query 220 despite having different text than the targeting keyword. For example, an advertisement having the targeting keyword “daisy” may also be selected as an eligible advertisement for an advertisement request including a resource keyword or search query for “flowers” because daisy is a type of flower, and therefore, is likely to be relevant to the word “flowers.”

The advertisement system 202 can select the eligible advertisements that are provided for presentation in advertisement slots of a resource or search results page based on results of an auction. For example, the advertisement system 202 can receive bids from advertisers and allocate the advertisement slots to the highest bidders at the conclusion of the auction. The bids are amounts that the advertisers are willing to pay for presentation (or selection) of their advertisement with a resource or search results page. For example, a bid can specify an amount that an advertiser is willing to pay for each 1000 impressions (i.e., presentations) of the advertisement, referred to as a CPM bid. Alternatively, the bid can specify an amount that the advertiser is willing to pay for a selection (i.e., a click-through) of the advertisement or a “conversion” following selection of the advertisement. The highest bidders can be determined based on the bids alone, or based on the bids of each bidder being multiplied by one or more factors, such as quality scores derived from advertisement performance, landing page scores, and the like.

Advertisers can also specify budgets for their advertisement campaigns. A budget is a specified amount that an advertiser is willing to pay for distribution of content over a specified budget period. The specified period can be, for example, a specified time (e.g., one day, one week, or one year), a specified number of events (e.g., a number of impressions or clicks), or some other delineation of time or events. Once the amount the advertiser is charged for distribution of content during the budget period matches or exceeds the budget amount, the campaign can be prevented from providing content for the remainder of the budget period unless the advertiser increases or overrides its specified budget.

A conversion occurs when a user performs a particular action related to an advertisement provided with a resource or search results page. What constitutes a conversion may vary from case to case and can be determined in a variety of ways. For example, a conversion may occur when a user clicks on an advertisement, is referred to a web page, and consummates a purchase there before leaving that web page. A conversion can also be defined by an advertiser to be any measurable/observable user action such as, for example, downloading a white paper, navigating to at least a given depth of a website, viewing at least a certain number of web pages, spending at least a predetermined amount of time on a website or web page, or registering on a website. Other actions that constitute a conversion can also be used.

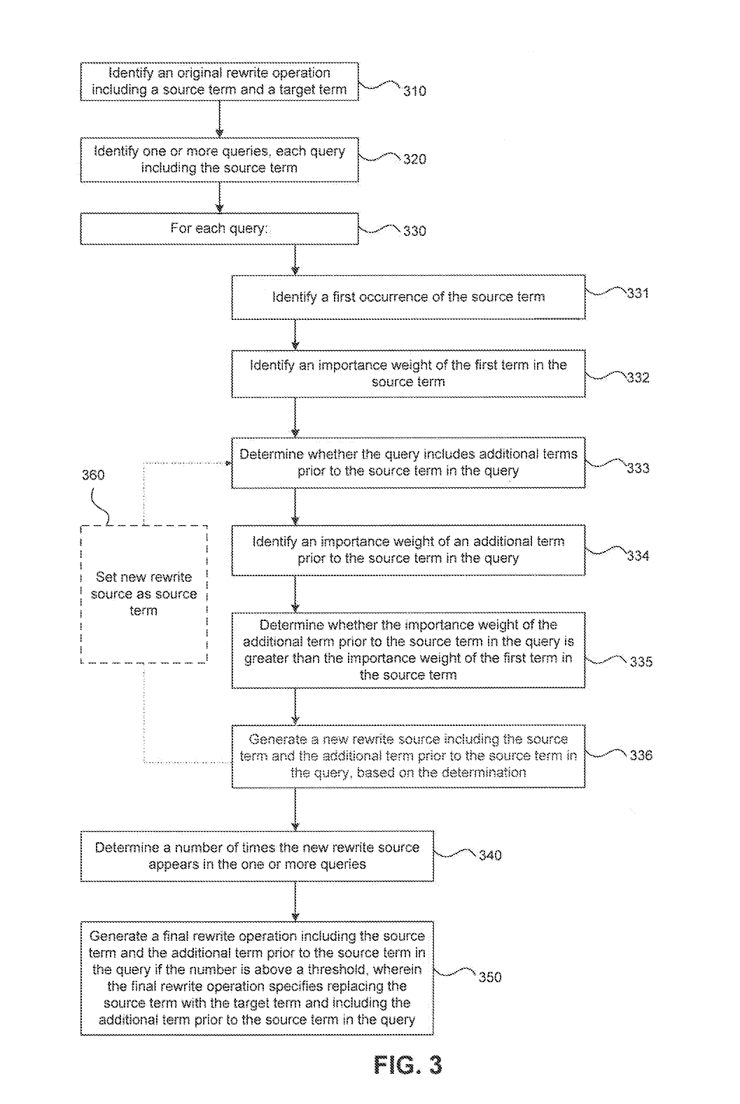

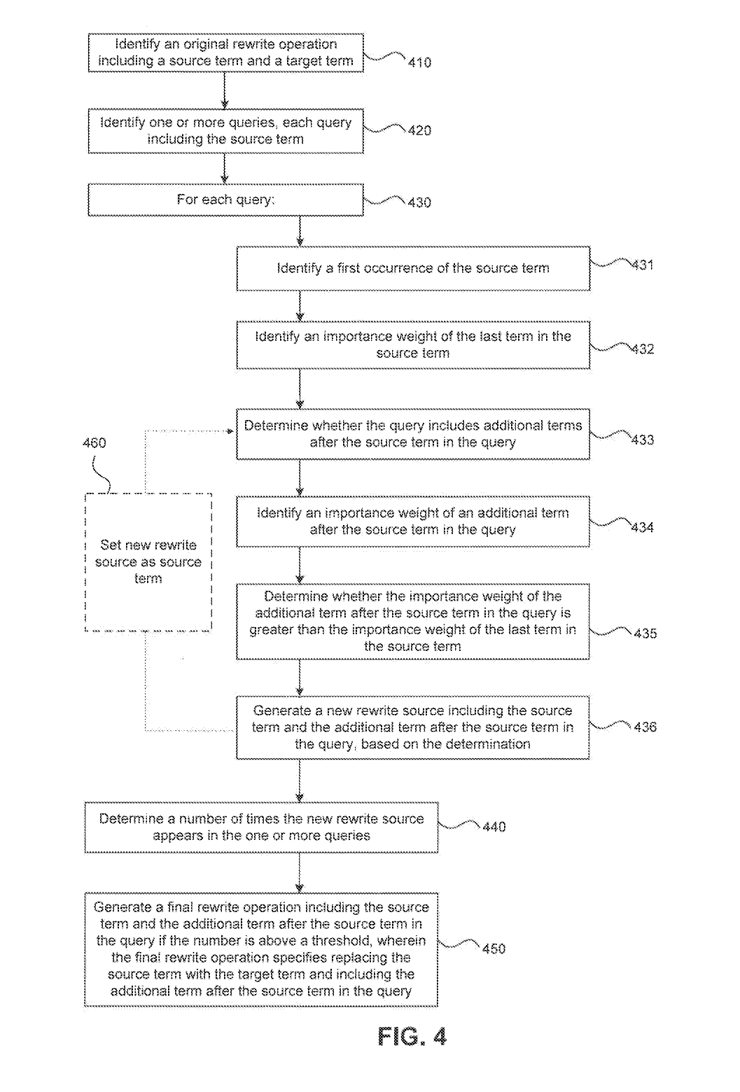

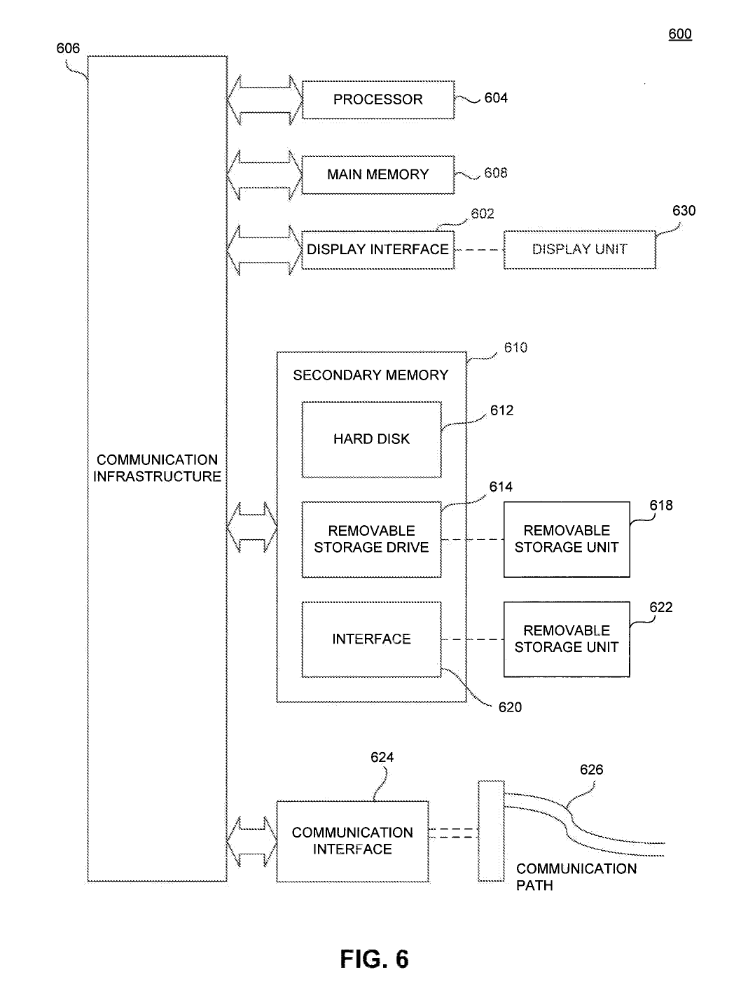

Each advertisement provided by an advertiser 210 can be associated with a one or more keywords selected by the advertiser. The advertisement system 202 can facilitate the generation of keywords to associate with search queries offline. The keywords are generated by substituting synonyms or by deleting words from the query as well as using other functions such as replacing words with other words. In addition, keywords may be generated by identifying the importance of the context of a query to generate contextualized rewrites. Generating new rewrite operations may be performed offline with the assistance of contextualized rewrite generator 120. New rewrite operations may be generated in accordance with methods 300 and 400 of FIG. 3 and FIG. 4, respectively. A system that can be used to implement these examples is then described with reference to FIG. 6.

FIG. 3 illustrates an exemplary method 300 for generating new rewrite operators, according to an embodiment.

In step 310, an original rewrite operation, including a source term and a query term, is identified. The original rewrite operation may be from a database of rewrite operations, such as rewrite operators 230. The rewrite operation can be a function to replace a word with another word, to delete a word, or to add a word to a query.

In step 320, one or more queries, each query including the source term, are identified. Queries may be obtained from a log of user-entered queries or queries generated by other methods. The identified queries each contain the source term.

Steps 331 through 336 of method 300 are performed for each query. At step 331, a first occurrence of the source term is identified. For example, the first occurrence of the source term may be the third term in the query.

In step 332, an importance weight of the first term in the source term is identified. If the source term is only one word, the importance weight is determined for that word. As specified above, the importance weight may be based on the IDF or IQF of the source term, or another importance weight measure.

In step 333, a determination is made as to whether any terms exist prior to the source term. For languages written from left to right, such as English, a determination is made as to whether any terms exist to the left of the source term.

In step 334, if an additional term prior to the source term exists, an importance weight of the additional term is identified.

In step 335, a determination is made as to whether the importance weight of the additional term prior to the source term is greater than the importance weight of the first term in the source term. Therefore, the importance weight of the first term in the source term is compared to the importance weight of the additional term.

In step 336, if the determination of step 335 is that the importance weight of the additional term is greater than the importance weight of the first term in the source term, a new rewrite source is generated that includes both the source term and the additional term prior to the source term. As stated above, steps 331 through 336 may be repeated for each query identified at step 320.

In step 340, the one or more queries identified at 320 may be searched to determine how many times a new rewrite source appears in the one or more queries. For example, in a set of 1,000,000 queries, a new rewrite source may appear in 100,000 queries.

If the number of times the new rewrite source appears in the set of one or more queries meets a threshold, in step 350 then, a final rewrite operation is generated. The final rewrite operation may specify replacing the source term in the new rewrite source with the target term.

Once the final rewrite operation is generated, the final rewrite operation can be applied to queries online. For example, in an embodiment, an original search query may be received. The original search query may include the new rewrite source. New keywords may be generated by applying the final rewrite operation to the new rewrite source in the original search query. Once the final rewrite operation is applied, advertisements responsive to the generated keywords may be identified, and suggested to a user.

In an embodiment, for each query, a determination is made as to whether additional terms exist after the source term in the query. Based on the determination, an importance weight of an additional term after the source term is identified. If the importance weight of the additional term after the source term in the query is greater than the importance weight of the last term in the source term, the additional term may be added to generate a new rewrite source including the source term and the additional term after the source term.

In an embodiment, for each query, a determination may be made as to whether additional terms exist prior to the additional term prior to the source term in the query. That is to say, a determination may be made if the query includes three terms or more, and the source term has two additional terms prior to it. If such a term exists, an importance weight of the additional term prior to the first additional term may be identified. If the importance weight of the additional term prior to the first additional term is greater than the importance weight of the first additional term, the term may be added to the new rewrite source. For example, as in FIG. 3, the new rewrite source may be set as the source term at step 360, and steps 333 through 336 may be repeated to determine if any additional terms prior to the additional term prior to the source term in the query should be added to the rewrite source.

According to embodiments, as an example, consider query 112 “the clever brown fox jumps over the lazy dog.” An original rewrite operation 108 may be identified, in accordance with block 310 that specifies BROWN FOX is to be replaced by RED WOLF. Thus, in accordance with block 320, one or more queries, each query including the source term, may be identified. Query 112 includes the source term “brown”.

In accordance with block 331, for query 112, the first occurrence of the source term of the rewrite rule may be identified after the second word in the query. In accordance with block 332, the importance weight of the first term in the source term “brown” is identified as 4.0. The determination as to whether the query includes additional terms prior to the source term, in accordance with block 333, may lead to an identification of the additional term “clever”. Thus, in accordance with block 333, the importance weight of the additional term “clever” may be identified to be 10.0. In accordance with block 334, because the importance weight of the term “clever” is greater than the importance weight of the term “brown” (10.0 is greater than 4.0), the term “clever” may be added to a new rewrite source to generate a new rewrite source of “clever brown fox”, in accordance with block 336.

In accordance with block 340, queries 110 may be searched to determine how many times the new rewrite source appears in the list of queries. If the number of times the new rewrite “clever brown fox” appears in the list of queries meets a threshold, in accordance with block 350, then a final rewrite operation 131 may be generated that specifies “clever brown fox” should be rewritten to “clever red wolf”.

Thus, a user may enter an original search query containing the phrase “clever brown fox”. According to the final rewrite operation 131, “clever brown fox” may be rewritten to be “clever red wolf”. Advertisements responsive to new keywords “clever red wolf” may be identified and displayed for the user to view.

According to an embodiment, steps 310, 320, 331, 332, 333, 334, 335, 336, 340 and 350 may be performed by an advertisement module 202 and a contextualized rewrite generator 120.

FIG. 4 illustrates an exemplary method 400 for generating new rewrite operators, according to an embodiment.

In step 410, an original rewrite operation, including a source term and a query term, is identified. The original rewrite operation may be from a database of rewrite operations, such as rewrite operators 230. The rewrite operation can be a function to replace a word with another word, to delete a word, or to add a word to a query.

In step 420, one or more queries, each query including the source term, are identified. Queries may be obtained from a log of user-entered queries or queries generated by other methods.

Steps 431 through 436 of method 400 are performed for each query. At step 431, a first occurrence of the source term is identified. For example, the first occurrence of the source term may be the third term in the query.

In step 432, an importance weight of the last term in the source term is identified. If the source term is only one word, the importance weight is determined for that word. As specified above, the importance weight may be based on the IDF or IQF of the source term, or another importance weight measure.

In step 433, a determination is made as to whether any terms exist after the source term. For languages written from left to right, such as English, a determination is made as to whether any terms exist to the right of the source term.

In step 434, if an additional term after the source term exists, an importance weight of the additional term is identified.

In step 435, a determination is made as to whether the importance weight of the additional term after the source term is greater than the importance weight of the last term in the source term.

In step 436, if the determination of step 435 is that the importance weight of the additional term is greater than the importance weight of the last term in the source term, a new rewrite source is generated that includes both the source term and the additional term after the source term. As stated above, steps 431 through 436 may be repeated for each query identified at step 420.

In step 440, the one or more queries identified at 420 may be searched to determine how many times the new rewrite source appears in the one or more queries. For example, in a set of 1,000,000 queries, the new rewrite source may appear in 100,000 queries.

If the number of times the new rewrite source appears in the set of one or more queries meets a threshold, in step 450 then, a final rewrite operation is generated. The final rewrite operation may specify replacing the source term in the new rewrite source with the target term.

Once the final rewrite operation is generated, the final rewrite operation can be applied to queries online. For example, in an embodiment, an original search query may be received. The original search query may include the new rewrite source. New keywords may be generated by applying the final rewrite operation to the new rewrite source in the original search query. Once the final rewrite operation is applied, advertisements responsive to the generated keywords may be identified, and suggested to a user. In some embodiments, as additional rewrite operations are generated, the additional rewrite operations can be used to generate further new keywords. Thus, for subsequent queries, these additional rewrite operations can be used to identify advertisements responsive to further new keywords.

In an embodiment, for each query, a determination is made as to whether additional terms exist prior to the source term in the query. Based on the determination, an importance weight of an additional term prior to the source term is identified. If the importance weight of the additional term prior to the source term in the query is greater than the importance weight of the first term in the source term, the additional term may be added to generate a new rewrite source including the source term and the additional term after the source term.

In an embodiment, for each query, a determination may be made as to whether additional terms exist after the additional term after the source term in the query. That is to say, a determination may be made if the query includes three terms or more, and the source term has two additional terms after it. If such a term exists, an importance weight of the additional term after the first additional term may be identified. If the importance weight of the additional term after the first additional term is greater than the importance weight of the first additional term, the term may be added to the new rewrite source. For example, as in FIG. 4, the new rewrite source may be set as the source term at step 460, and steps 433 through 436 may be repeated to determine if any additional terms after the additional term after the source term in the query should be added to the rewrite source.

According to embodiments, as an example, consider query 112 “the clever brown fox jumps over the lazy dog.” An original rewrite operation or rule 108 may be identified, in accordance with block 410 that specifies BROWN FOX is to be replaced by RED WOLF. Thus, in accordance with block 420, one or more queries, each query including the source term, may be identified. Query 112 includes the source term “brown fox”.

In accordance with block 431, for query 112, the first occurrence of the source term of the rewrite rule may be identified after the second word in the query. In accordance with block 432, the importance weight of the last term in the source term “fox” is identified as 6.0. The determination as to whether the query includes additional terms prior to the source term, in accordance with block 433, may lead to an identification of the additional term “jumps”. Thus, in accordance with block 433, the importance weight of the additional term “jumps” may be identified to be 8.0. In accordance with block 434, because the importance weight of the term “jumps” is greater than the importance weight of the term “fox”, the term “jumps” may be added to a new rewrite source to generate a new rewrite source of “brown fox jumps”, in accordance with block 436.

In accordance with block 440, queries 110 may be searched to determine how many times the new rewrite source appears in the list of queries. If the number of times the new rewrite “brown fox jumps” appears in the list of queries meets a threshold, in accordance with block 450, then a final rewrite operation 132 may be generated that specifies “brown fox jumps” should be rewritten to “red wolf jumps”.

As mentioned, the above methods of generating contextualized rewrites may be expanded to include additional query terms. For example, query 112 includes an additional term after the term “jumps”. Since the importance weight of additional term “over” is greater than the importance weight of term “jumps”, the additional teen may be added to generate a new rewrite source “brown fox jumps over”. If the number of times new rewrite source “brown fox jumps over” appears in queries 110 meets a threshold, a final rewrite operation may be generated that specifies “brown fox jumps over” should be replaced with “red wolf jumps over”.

According to embodiments disclosed herein, if the importance weight of an additional term is not greater than the importance weight of a source term or another term either prior to or after the additional term (depending on embodiments), the additional term may not be included in a new rewrite source. Embodiments may use a greedy or hill-climbing algorithm to determine the length of a new rewrite source. Thus, provided the importance weight of a term to be added is greater than the importance weight of the term immediately prior to or after the term to be added, the term to be added may be included in the new rewrite source.

In accordance with embodiments, terms prior to and after the source term may be added to generate new rewrite sources and final rewrite operations. In the example of FIG. 1, term “clever” is prior to source term “brown fox”, and has a greater importance weight than the first term in the source term. Additionally, term “jumps” is after source term “brown fox”, and has a greater importance weight than the source term. Thus, a new rewrite source may be generated that includes term “clever” and term “jumps” to read “clever brown fox jumps”. In accordance with embodiments, if the number of times new rewrite source “clever brown fox jumps” appears in the set of queries meets a threshold, a final rewrite operation 133 may be generated that specifies “clever brown fox jumps” should be rewritten to “clever red wolf jumps”.

As detailed above, if the query contains further additional terms, these terms may be added to generate new rewrite sources and final rewrite operations. For example, query term “over” has a higher importance weight than query term “jumps”. Thus, in accordance with embodiments, query term “over” may be added to generate a new rewrite source 118 “clever brown fox jumps over”. Accordingly, if the number of times “clever brown fox jumps over” appears in the set of queries meets a threshold, a final rewrite operation may be generated that specifies “clever brown fox jumps over” should be rewritten to “clever red wolf jumps over”.

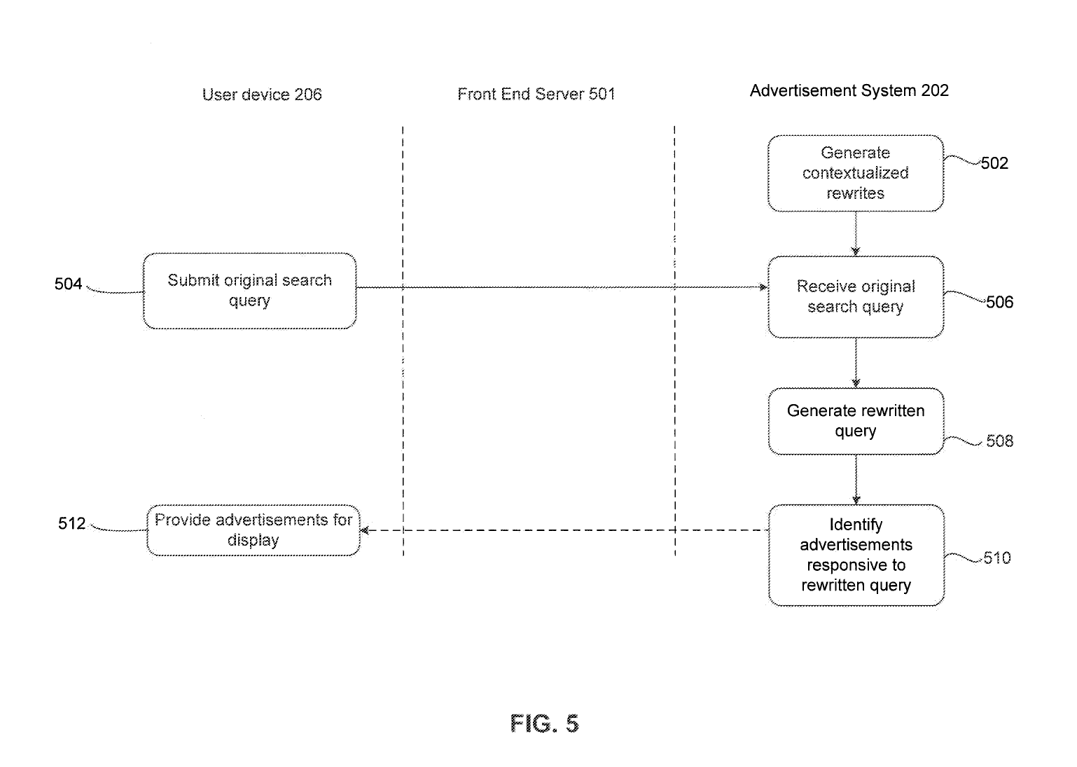

FIG. 5 is a swim lane diagram illustrating a process for calculating quality scores for rewrite operators. In this illustration, a remote server system (e.g., au advertisement system 202) generates contextualized rewrites in step 502, as detailed in steps 350 and 450 of methods 300 and 400. Contextualized rewrite operations can be used to rewrite queries. A user device 206 may submit an original search query in step 504. The server system, at step 506, may receive the original search query. A rewritten query may be generated by the server system at step 508 by applying the contextualized rewrites. Based on the rewritten query generated at step 508, advertisements responsive to the rewritten query may be identified at step 510 by advertisement system 202. User device 206 may then display the identified advertisements at step 512.

FIG. 6 illustrates an example computer system 600 in which embodiments of the present invention, or portions thereof, may be implemented as computer-readable code. For example, advertisement system 202 may be implemented in computer system 600 using hardware, software, firmware, tangible computer readable media having instructions stored thereon, or a combination thereof and may be implemented in one or more computer systems or other processing systems. Hardware, software, or any combination of such may embody any of the modules and components in FIGS. 1-5.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

Various embodiments of the invention are described in terms of this example computer system 600. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general-purpose processor device. As will be appreciated by persons skilled in the relevant art, processor device 604 may also be a single processor in a multi-core/multiprocessor system, such system operating alone, or in a cluster of computing devices operating in a cluster or server farm. Processor device 604 is connected to a communication infrastructure 606, for example, a bus, message queue, network, or multi-core message-passing scheme.

Computer system 600 also includes a main memory 608, for example, random access memory (RAM), and may also include a secondary memory 610. Secondary memory 610 may include, for example, a hard disk drive 612, removable storage drive 614. Removable storage drive 614 may comprise a floppy disk drive, a magnetic tape drive, an optical disk drive, a flash memory, or the like. The removable storage drive 614 reads from and/or writes to a removable storage unit 618 in a well-known manner. Removable storage unit 618 may comprise a floppy disk, magnetic tape, optical disk, etc., which is read by and written to by removable storage drive 614. As will be appreciated by persons skilled in the relevant art, removable storage unit 618 includes a computer usable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 may be in the form of signals, which may be electronic, electromagnetic, optical, or other signals capable of being received by communications interface 624. These signals may be provided to communications interface 624 via a communications path 626. Communications path 626 carries signals and may be implemented using wire or cable, fiber optics, a phone line, a cellular phone link, an RF link or other communications channels.

In this document, the terms “computer program storage medium,” “computer usable storage medium,” and “computer readable storage medium” are used to generally refer to media such as removable storage unit 618, removable storage unit 622, and a hard disk installed in hard disk drive 612. Computer program medium, computer usable medium, and computer readable storage medium may also refer to memories, such as main memory 608 and secondary memory 610, which may be memory semiconductors (e.g. DRAMs, etc.). These do not refer to transitory signals of software and data.

Computer programs (also called computer control logic) are stored in main memory 608 and/or secondary memory 610. Computer programs may also be received via communications interface 624. Such computer programs, when executed, enable computer system 600 to implement the present invention as discussed herein. In particular, the computer programs, when executed, enable processor device 604 to implement the processes of the present invention, such as the stages in the method illustrated by flowchart 300 of FIG. 3 discussed above. Accordingly, such computer programs represent controllers of the computer system 600. Where the invention is implemented using software, the software may be stored in a computer program product and loaded into computer system 600 using removable storage drive 614, interface 620, and hard disk drive 612, or communications interface 624.

Embodiments of the invention also may be directed to computer program products comprising software stored on any computer readable storage medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer-implemented method, comprising:
identifying, by a contextualized rewrite generator specifically configured to generate query rewrite operations that are used in rewriting queries submitted by user devices, an original rewrite operation including a source term and a target term;
identifying one or more queries, each query including the source term;
for each query:
identifying a first occurrence of the source term;
identifying an importance weight of a first term in the source term;
determining whether the query includes additional terms prior to the source term in the query;
identifying an importance weight of an additional term prior to the source term in the query based on the determination;
determining whether the importance weight of the additional term prior to the source term in the query is greater than the importance weight of the first term in the source term;
generating, by the contextualized rewrite generator, a new rewrite source including the source term and the additional term prior to the source term in the query, based on the determination;
determining a number of times the new rewrite source appears in the one or more queries; and
generating, by the contextualized rewrite generator, a final rewrite operation including the new rewrite source if the number meets a threshold, wherein the final rewrite operation specifies replacing the source term in the new rewrite source with the target term;
receiving a search query submitted by a user device;
generating, after receiving the search query and prior to providing content responsive to the search query, a rewritten query based on rewriting the received query using the final rewrite operation, wherein the rewritten query differs from the search query submitted by the user device;
receiving, from a search system and in response to submitting the rewritten query to the search system, content selected by the search system using the rewritten query; and
providing, to the user device, and in response to the received search query, the received content.

2. The method of claim 1, further comprising:
for each query:
determining whether the query includes additional terms after the source term in the query;
identifying an importance weight of an additional term after the source term in the query based on the determination;
identifying an importance weight of a last term in the source term;
determining whether the importance weight of the additional term after the source term in the query is greater than the importance weight of the last term in the source term; and
generating the new rewrite source including the source term and the additional term after the source term in the query, based on the determination.

3. The method of claim 1, further comprising:
for each query:
determining whether the query includes further additional terms prior to the additional term prior to the source term in the query;
identifying an importance weight of an additional term prior to the additional term prior to the source term in the query based on the determination;
determining whether the importance weight of the additional term prior to the additional term prior to the source term in the query is greater than the importance weight of the additional term prior to the source term in the query; and
generating the new rewrite source including the additional term prior to the source term in the query and the additional term prior to the additional term prior to the source term in the query.

4. The method of claim 1, wherein the search query submitted by the user device includes the new rewrite source, the method further comprising:
generating keywords by applying the final rewrite operation to the new rewrite source in the search query submitted by the user device;
submitting the generated keywords to an advertising system that is configured to identify advertisements that are responsive to keywords; and
providing, to the user device, one or more advertisements received from the advertising system that the advertising system identifies as responsive to the generated keywords.

5. A computer-implemented method, comprising:
identifying, by a contextualized rewrite generator specifically configured to generate query rewrite operations that are used in rewriting queries submitted by user devices, an original rewrite operation including a source term and a target term;
identifying one or more queries, each query including the source term;
for each query:
identifying a first occurrence of the source term;
identifying an importance weight of a last term in the source term;
determining whether the query includes additional terms after the source term in the query;
identifying an importance weight of an additional term after the source term in the query based on the determination;
determining whether the importance weight of the additional term after the source term in the query is greater than the importance weight of the last term in the source term;
generating, by the contextualized rewrite generator, a new rewrite source including the source term and the additional term after the source term in the query, based on the determination;
determining a number of times the new rewrite source appears in the one or more queries; and
generating, by the contextualized rewrite generator, a final rewrite operation including the new rewrite source if the number meets a threshold, wherein the final rewrite operation specifies replacing the source term in the new rewrite source with the target term
receiving a search query submitted by a user device;
generating, after receiving the search query and prior to providing content responsive to the search query, a rewritten query based on rewriting the received query using the final rewrite operation, wherein the rewritten query differs from the search query submitted by the user device;
receiving, from a search system and in response to submitting the rewritten query to the search system, content selected by the search system using the rewritten query; and
providing, to the user device, and in response to the received search query, the received content.

6. The method of claim 5, further comprising:
for each query:
determining whether the query includes additional terms prior to the source term in the query;
identifying an importance weight of an additional term prior to the source term in the query based on the determination;
identifying an importance weight of a first term in the source term;
determining whether the importance weight of the additional term prior to the source term in the query is greater than the importance weight of the first term in the source term; and
generating the new rewrite source including the source term and the additional term prior to the source term in the query, based on the determination.

7. The method of claim 5, further comprising:
for each query:
determining whether the query includes further additional terms after the additional term after the source term in the query;
identifying an importance weight of an additional term after the additional term after the source term in the query based on the determination;
determining whether the importance weight of the additional term after the additional term after the source term in the query is greater than the importance weight of the additional term after the source term in the query; and
generating the new rewrite source including the additional term after the source term in the query and the additional term after the additional term prior to the source term in the query.

8. The method of claim 5, wherein the search query submitted by the user device includes the new rewrite source, the method further comprising:
generating keywords by applying the final rewrite operation to the new rewrite source in the search query submitted by the user device;
submitting the generated keywords to an advertising system that is configured to identify advertisements that are responsive to keywords; and
providing, to the user device, one or more advertisements received from the advertising system that the advertising system identifies as responsive to the generated keywords.

9. An advertising system, comprising:
one or more processors configured to execute computer program instructions; and
a non-transitory computer storage medium encoded with computer program instructions that, when executed by the one or more processors, cause the system to perform operations comprising:
identify, by a contextualized rewrite generator specifically configured to generate query rewrite operations that are used in rewriting queries submitted by user devices, an original rewrite operation including a source term and a target term;
identify one or more queries, each query including the source term;
for each query:
identify a first occurrence of the source term;
identify an importance weight of a first term in the source term;
identify an importance weight of a last term in the source term;
determine whether the query includes additional terms prior to the source term in the query;
identify an importance weight of an additional term prior to the source term in the query based on the determination;
determine whether the importance weight of the additional term prior to the source term in the query is greater than the importance weight of the first term in the source term;
generate, by the contextualized rewrite generator, a new rewrite source including the source term and the additional term prior to the source term in the query, based on the determination;
determine whether the query includes additional terms after the source term in the query;
identify an importance weight of an additional term after the source term in the query based on the determination;
determine whether the importance weight of the additional term after the source term in the query is greater than the importance weight of the last term in the source term;
generate, by the contextualized rewrite generator, the new rewrite source including the source term and the additional term in the query, based on the determination;
determine a number of times the new rewrite source appears in the one or more queries; and
generate, by the contextualized rewrite generator, a final rewrite operation including the new rewrite source if the number meets a threshold, wherein the final rewrite operation specifies replacing the source term in the new rewrite source with the target term;
receive a search query submitted by a user device;
generate, after receiving the search query and prior to providing content responsive to the search query, a rewritten query based on rewriting the received query using the final rewrite operation, wherein the rewritten query differs from the search query submitted by the user device;
receive, from a search system and in response to submitting the rewritten query to the search system, content selected by the search system using the rewritten query; and
provide to the user device, and in response to the received search query, the received content.

10. The system of claim 9, wherein the advertisement system is further configured to:
for each query:
determine whether the query includes further additional terms prior to the additional term prior to the source term in the query;
identify an importance weight of an additional term prior to the additional term prior to the source term in the query based on the determination;
determine whether the importance weight of the additional term prior to the additional term prior to the source term in the query is greater than the importance weight of the additional term prior to the source term in the query; and
generate the new rewrite source including the additional term prior to the source term in the query and the additional term prior to the additional term prior to the source term in the query, based on the determination.

11. The system of claim 9, wherein the advertisement system is further configured to:
for each query:
determine whether the query includes further additional terms after the additional term after the source term in the query;
identify an importance weight of an additional term after the additional term after the source term in the query based on the determination;
determine whether the importance weight of the additional term after the additional term after the source term in the query is greater than the importance weight of the additional term after the source term in the query; and
generate the new rewrite source including the additional term after the source term in the query and the additional term after the additional term after the source term in the query.

12. The system of claim 9, wherein the search query submitted by the user device includes the new rewrite source, and wherein the advertisement system is further configured to:
generate keywords by applying the final rewrite operation to the new rewrite source in the search query submitted by the user device;
submit the generated keywords to an advertising system that is configured to identify advertisements that are responsive to keywords; and
provide, to the user device, one or more advertisements received from the advertising system that the advertising system identifies as responsive to the generated keywords.

13. A non-transitory computer readable storage medium encoded with a computer program, the program comprising instructions that when executed by one or more processors cause the one or more processors to perform operations comprising:
identifying, by a contextualized rewrite generator specifically configured to generate query rewrite operations that are used in rewriting queries submitted by user devices, an original rewrite operation including a source term and a target term;
identifying one or more queries, each query including the source term;
for each query:
identifying a first occurrence of the source term;
identifying an importance weight of a first term in the source term;
determining whether the query includes additional terms prior to the source term in the query;
identifying an importance weight of an additional term prior to the source term in the query based on the determination;
determining whether the importance weight of the additional term prior to the source term in the query is greater than the importance weight of the first term in the source term;
generating, by the contextualized rewrite generator, a new rewrite source including the source term and the additional term prior to the source term in the query, based on the determination;
determining a number of times the new rewrite source appears in the one or more queries; and
generating, by the contextualized rewrite generator, a final rewrite operation including the new rewrite source if the number meets a threshold, wherein the final rewrite operation specifies replacing the source term in the new rewrite source with the target term;
receiving a search query submitted by a user device;
generating, after receiving the search query and prior to providing content responsive to the search query, a rewritten query based on rewriting the received query using the final rewrite operation, wherein the rewritten query differs from the search query submitted by the user device;
receiving, from a search system and in response to submitting the rewritten query to the search system, content selected by the search system using the rewritten query; and
providing, to the user device, and in response to the received search query, the received content.

14. The computer readable storage medium of claim 13, the operations further comprising:
for each query:
determining whether the query includes additional terms after the source term in the query;
identifying an importance weight of an additional term after the source term in the query based on the determination;
identifying an importance weight of a last term in the source term;
determining whether the importance weight of the additional term after the source term in the query is greater than the importance weight of the last term in the source term; and
generating the new rewrite source including the source term and the additional term after the source term in the query, based on the determination.

15. The computer readable storage medium of claim 13, the operations further comprising:
for each query:
determining whether the query includes further additional terms prior to the additional term prior to the source term in the query;
identifying an importance weight of an additional term prior to the additional term prior to the source term in the query based on the determination;
determining whether the importance weight of the additional term prior to the additional term prior to the source term in the query is greater than the importance weight of the additional term prior to the source term in the query; and
generating the new rewrite source including the additional term prior to the source term in the query and the additional term prior to the additional term prior to the source term in the query.

16. The computer readable storage medium of claim 13, wherein the search query submitted by the user device includes the new rewrite source, the operations further comprising:
generating keywords by applying the final rewrite operation to the new rewrite source in the search query submitted by the user device;
submitting the generated keywords to an advertising system that is configured to identify advertisements that are responsive to keywords; and
providing, to the user device, one or more advertisements received from the advertising system that the advertising system identifies as responsive to the generated keywords.

17. A non-transitory computer readable storage medium encoded with a computer program, the program comprising instructions that when executed by one or more processors cause the one or more processors to perform operations comprising:
identifying, by a contextualized rewrite generator specifically configured to generate query rewrite operations that are used in rewriting queries submitted by user devices, an original rewrite operation including a source term and a target term;
identifying one or more queries, each query including the source term;
for each query:
identifying a first occurrence of the source term;
identifying an importance weight of a last term in the source term;
determining whether the query includes additional terms after the source term in the query;
identifying an importance weight of an additional term after the source term in the query based on the determination;
determining whether the importance weight of the additional term after the source term in the query is greater than the importance weight of the last term in the source term;
generating, by the contextualized rewrite generator, a new rewrite source including the source term and the additional term after the source term in the query, based on the determination;
determining a number of times the new rewrite source appears in the one or more queries; and
generating, by the contextualized rewrite generator, a final rewrite operation including the new rewrite source if the number meets a threshold, wherein the final rewrite operation specifies replacing the source term in the new rewrite source with the target term
receiving a search query submitted by a user device;
generating, after receiving the search query and prior to providing content responsive to the search query, a rewritten query based on rewriting the received query using the final rewrite operation, wherein the rewritten query differs from the search query submitted by the user device;
receiving, from a search system and in response to submitting the rewritten query to the search system, content selected by the search system using the rewritten query; and
providing, to the user device, and in response to the received search query, the received content.

18. The computer readable storage medium of claim 17, the operations further comprising:
for each query:
determining whether the query includes additional terms prior to the source term in the query;
identifying an importance weight of an additional term prior to the source term in the query based on the determination;
identifying an importance weight of a first term in the source term;
determining whether the importance weight of the additional term prior to the source term in the query is greater than the importance weight of the first term in the source term; and
generating the new rewrite source including the source term and the additional term prior to the source term in the query, based on the determination.

19. The computer readable storage medium of claim 17, the operations further comprising:
for each query:
determining whether the query includes further additional terms after the additional term after the source term in the query;
identifying an importance weight of an additional term after the additional term after the source term in the query based on the determination;
determining whether the importance weight of the additional term after the additional term after the source term in the query is greater than the importance weight of the additional term after the source term in the query; and
generating the new rewrite source including the additional term after the source term in the query and the additional term after the additional term prior to the source term in the query.

20. The computer readable storage medium of claim 17, wherein the search query submitted by the user device includes the new rewrite source, the operations further comprising:
generating keywords by applying the final rewrite operation to the new rewrite source in the search query submitted by the user device;
submitting the generated keywords to an advertising system that is configured to identify advertisements that are responsive to keywords; and
providing, to the user device, one or more advertisements received from the advertising system that the advertising system identifies as responsive to the generated keywords.
